(19) United States
(12) Patent Application Publication
(10) Pub. No.: US 2022/0023136 A1
(43) Pub. Date: Jan. 27, 2022

(54) METHOD FOR GUIDING A BLIND, ELECTRONIC DEVICE, STORAGE MEDIUM, AND BLIND GUIDE PRODUCT

(71) Applicant: BEIJING BAIDU NETCOM SCIENCE TECHNOLOGY CO., LTD., Beijing (CN)

(72) Inventors: Lei XIA, Beijing (CN); Xi CHEN, Beijing (CN); Hailu JIA, Beijing (CN); Guangdi SHAN, Beijing (CN)

(21) Appl. No.: 17/492,650

(22) Filed: Oct. 3, 2021

(30) Foreign Application Priority Data
Feb. 7, 2021 (CN) 202110168063.8

(51) Int. Cl. A61H 3/06; G01C 21/36; G01C 21/34; G01S 19/43

(52) U.S. Cl. CPC A61H 3/061; G01C 21/3629; G01S 19/43; G01C 21/3492; G01C 21/3602; G01C 21/3608

(57) ABSTRACT

A method for guiding a blind, an electronic device, a storage medium and a blind guide product, and related to the technical field of navigation are provided. The method includes: acquiring Beidou satellite data and base station differential data, and determining location information of a user by using a carrier phase differential technology; in response to a blind guide request, generating a blind guide route according to current location information and destination information input by the user; and broadcasting a voice prompt based on the blind guide route. The location accuracy of a user is improved, and blind guide requirements for a complex road section can be met, thereby improving the travel safety for the user.

### CROSS-REFERENCE TO RELATED APPLICATION

This application claims priority to Chinese patent application No. 202110168063.8, filed on Feb. 7, 2021, which is hereby incorporated by reference in its entirety.

### TECHNICAL FIELD

The present disclosure relates to the technical field of navigation, and in particular, to the technical fields of satellite positioning and map navigation.

### BACKGROUND

A blind guide tool in the related art, such as a blind guide stick, usually locates the position of a blind by using a global positioning system (GPS), and guides the blind by using ultrasonic distance measurement.

### SUMMARY

The present disclosure provides a method for guiding a blind, an apparatus, a device, a storage medium, and a product.

According to an aspect of the present disclosure, there is provided a method for guiding a blind, including:

acquiring Beidou satellite data and base station differential data, and determining location information of a user by using a carrier phase differential technology;

in response to a blind guide request, generating a blind guide route according to current location information and destination information input by the user; and

broadcasting a voice prompt based on the blind guide route.

According to another aspect of the present disclosure, there is provided an apparatus for guiding a blind, including:

a location module, configured for acquiring Beidou satellite data and base station differential data, and determining location information of a user by using a carrier phase differential technology;

a blind guide route generation module, configured for in response to a blind guide request, generating a blind guide route according to current location information and destination information input by the user; and

a prompt module, configured for broadcasting a voice prompt based on the blind guide route.

According to another aspect of the present disclosure, there is provided an electronic device, including:

at least one processor; and

a memory communicatively connected with the at least one processor, wherein

the memory stores instructions executable by the at least one processor, the instructions being executed by the at least one processor to enable the at least one processor to execute the method according to any embodiment of the present disclosure.

According to another aspect of the present disclosure, there is provided a non-transitory computer-readable storage medium storing computer instructions for enabling a computer to execute the method according to any embodiment of the present disclosure.

According to another aspect of the present disclosure, there is provided a computer program product including a computer program which, when executed by a processor, causes the processor to execute the method according to any embodiment of the present disclosure is implemented.

According to another aspect of the present disclosure, there is provided a blind guide product, including the apparatus for guiding a blind according to any implementation of the present disclosure.

It should be understood that the content described in this section is neither intended to limit the key or important features of the embodiments of the present disclosure, nor intended to limit the scope of the present disclosure. Other features of the present disclosure will be readily understood through the following description.

### BRIEF DESCRIPTION OF THE DRAWINGS

The drawings are used to better understand the solution and do not constitute a limitation to the present disclosure. In which:

FIG. 1 is a flowchart of a method for guiding a blind according to an embodiment of the present disclosure;

FIG. 2 is a specific flowchart of generating a blind guide route according to an embodiment of the present disclosure;

FIG. 3 is a specific flowchart of broadcasting a voice prompt according to an embodiment of the present disclosure;

FIG. 4 is a specific flowchart of broadcasting a voice prompt according to an embodiment of the present disclosure;

FIG. 5 is a specific flowchart of broadcasting a voice prompt according to an embodiment of the present disclosure;

FIG. 6 is a specific flowchart of obstacle detecting according to an embodiment of the present disclosure;

FIG. 7 is a schematic diagram of an apparatus for guiding a blind according to an embodiment of the present disclosure;

FIG. 8 is a schematic diagram of a product for guiding a blind according to an embodiment of the present disclosure; and

FIG. 9 is a block diagram of an electronic device for implementing a method for guiding a blind according to an embodiment of the present disclosure.

### DETAILED DESCRIPTION

Exemplary embodiments of the present disclosure are described below in combination with the drawings, including various details of the embodiments of the present disclosure to facilitate understanding, which should be considered as exemplary only. Thus, those of ordinary skill in the art should realize that various changes and modifications can be made to the embodiments described here without departing from the scope and spirit of the present disclosure. Likewise, descriptions of well-known functions and structures are omitted in the following description for clarity and conciseness.

It is extremely inconvenient for a blind to travel because of the loss of vision. To ensure safe travel, urban public places are paved with blind tracks, and the blind may use auxiliary tools to touch the blind tracks and surrounding objects, to judge the direction of travel and surrounding obstacles. Blind guide tools in the related art, such as blind guide sticks, usually locate the position of a blind through GPS, and guide the blind by using ultrasonic distance measurement. Conventional GPS technology is a pseudorange single-point location technology, which may be affected by satellite orbit errors, satellite clock errors, ionospheric delays, tropospheric delays, multipath effects and other errors. Moreover, the conventional GPS technology is also limited by the structure of the blind guide stick. With generally small antenna and weak satellite signal receiving capability, GPS has a location error of 10 to 20 meters, and cannot meet the blind guide requirements for a complex intersection.

Therefore, blind guide products in the related art, such as blind guide sticks, cannot achieve high-precision location of the blind, and cannot meet the blind guide requirements in complex scenarios.

Based on the foregoing technical problems existing in the related art, embodiments of the present disclosure provide a method for guiding a blind. The method of the embodiments of the present disclosure may be applied to products for guiding a blind, such as a blind guide stick, a blind guide device, or a blind guide robot.

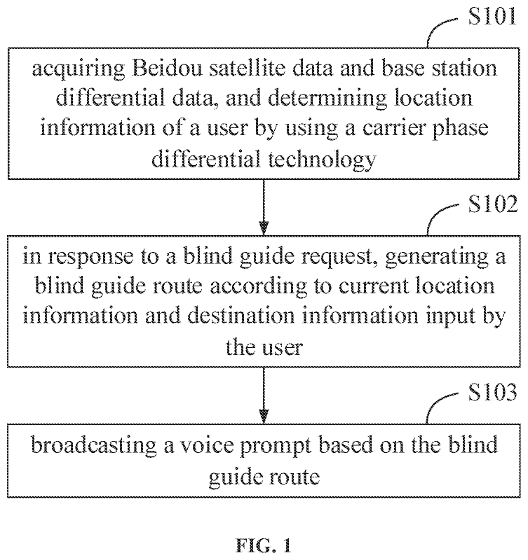

FIG. 1 shows a flowchart of a method for guiding a blind according to an embodiment of the present disclosure.

As shown in FIG. 1, the method includes:

S101: acquiring Beidou satellite data and base station differential data, and determining location information of a user by using a carrier phase differential technology.

S102: in response to a blind guide request, generating a blind guide route according to current location information and destination information input by the user; and

S103: broadcasting a voice prompt based on the blind guide route.

According to the technology of the present disclosure, the location accuracy of a user is improved, and blind guide requirements for a complex road section may be met, thereby improving the travel safety for the user.

Illustratively, in S101, the Beidou satellite data may be obtained through a Beidou chip. It may be understood that the Beidou chip may be a chipset integrated with a plurality of chips, specifically including an RF (Radio Frequency) chip, a baseband chip and a microprocessor chip. The Beidou satellite data transmitted by the Beidou satellite may be received through the Beidou chip.

The base station differential data may be obtained through a wireless communication module. The wireless communication module may be a communication module based on 2G, 3G, 4G, or 5G communication technologies. The communication module acquires the base station differential data from a service provider through an Ntrip protocol (Networked Transport of RTCM via Internet Protocol) according to an account provided by the service provider. After receiving the Beidou satellite data sent by the Beidou satellite, a reference base station sends base station data to the service provider. The service provider obtains base station differential data after processing the base station data, and then sends the base station differential data to the communication module. A plurality of base stations may be established within a certain area, to form a mesh coverage of the area, and one or more of these base stations may be used as the reference base station.

It should be noted that the carrier phase differential technology may be RTK (Real-Time Kinematic) carrier phase differential technology. The basic principle of the RTK carrier phase differential technology is to use observation data of a reference station network formed by a plurality of (at least three) continuously operating reference base stations to generate, in real time after calculation and processing, gridded base station differential data that is equivalent to observation data of a virtual reference station closer to a user, and is sent to the wireless communication module. Based on the base station differential data and the Beidou satellite data, using spatial correlation of observation errors between the reference base station and the user, most of the errors in the Beidou satellite data are removed in a differential manner, thereby obtaining high-precision location information.

The Beidou satellite data and the base station differential data are data at the same time. The carrier phase differential technology may be used to obtain location information of a user at that time, and locate the user in a sub-meter level, that is, the location information of the user is precise to decimeter, centimeter or even millimeter levels.

Illustratively, in S102, the blind guide request may be initiated by the user by voice, or by other manners such as operating a button on a blind guide product. A starting point location of the user may be determined by current location information, and a destination location of the user may be confirmed by destination information input by the user. A blind guide route is determined in preset map data based on the starting point location and the destination location.

Illustratively, in S103, the voice prompt is broadcast to the user according to the blind guide route and real-time updated user location information. For example, the user is prompted for the direction of travel, whether the user deviates from the blind guide route, and whether there is an obstacle nearby, so as to guide the blind to travel from the starting point location to the destination location.

According to the method for guiding a blind in the embodiments of the present disclosure, by acquiring the Beidou satellite data and the base station differential data, and obtaining the location information of the user through the carrier phase differential technology, the user may be precisely located in real time, and location accuracy may reach the sub-meter level. Moreover, the starting point location is determined based on the current location information of the user, the destination location is determined according to the destination information input by the user, and the blind guide route is planned based on the starting point location and the destination location, to meet the blind guide requirements in a complex scenario (such as an intersection). Furthermore, during the user's travel, real-time location information of the user is helpful to determine whether the user is travelling to a complex road section such as an intersection, and a voice prompt is broadcast to guide the blind through the complex road section such as the intersection, thereby ensuring that the user can reach the destination safely.

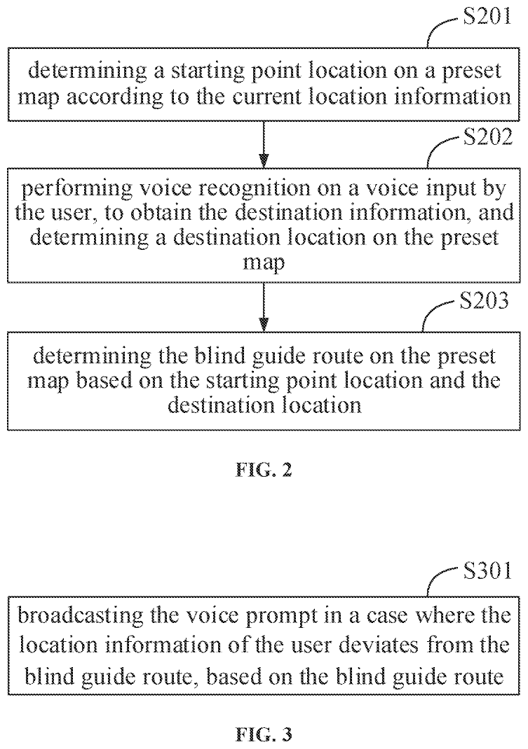

As shown in FIG. 2, in an implementation, S102 includes:

S201: determining a starting point location on a preset map according to the current location information;

S202: performing voice recognition on a voice input by the user, to obtain the destination information, and determining a destination location on the preset map; and

S203: determining the blind guide route on the preset map based on the starting point location and the destination location.

The preset map may be a high-precision electronic map, such as an electronic map precise to a lane level, to ensure the accuracy of the blind guide route in a complex scenario such as an intersection.

Illustratively, a voice input, a voice recognition and a broadcast reminder may be realized through an intelligent voice interaction module provided by the blind guide product. For example, in S202, the intelligent voice interaction module receives a voice “I want to go to the XXX hospital” input by a user, obtains the destination information, namely, “XXX hospital” through voice recognition, and determines a coordinate location of “XXX hospital” on a preset map, to get the destination location.

Illustratively, in S203, the blind guide route may be determined on the preset map by a route planning module disposed in the blind guide product. Specifically, a path generation algorithm may be used to generate a plurality of paths between the starting point location and the destination location through a topological link relationship between elements, and the shortest path may be determined from the plurality of paths as the blind guide route. In addition, the blind guide route may also be determined from the plurality of paths in combination with other factors such as a red light time at an intersection and a road congestion condition.

By means of the foregoing implementations, based on the precise location information of the user obtained in S101, the starting point location is determined on the preset map, the destination location is determined on the preset map based on the destination information input by the user, and the blind guide route is determined based on the starting point location and the destination location. As a result, the accuracy of the blind guide route is improved, and thus the route planning accuracy of complex scenarios such as intersections is improved, thereby improving travel safety for users.

As shown in FIG. 3, in an implementation, S103 includes:

S301: broadcasting the voice prompt in a case where the location information of the user deviates from the blind guide route, based on the blind guide route.

Illustratively, the location information of the user is updated in real time based on S101, and a minimum distance between the location information of the user and the blind guide route is calculated. In a case where the minimum distance reaches a preset value, it is determined that the location information of the user deviates from the blind guide route, and a voice prompt is broadcast to remind the user that he has deviated from the blind guide route currently and travels in a direction toward the blind guide route, to guide the user back to the blind guide route.

It should be noted that, based on locating the user in a sub-meter level in S101, the preset distance may be a meter level or a decimeter level, for example, the preset value may be 0.5 meters. As a result, a voice prompt may be broadcast immediately in a case where the user deviates from the blind guide route by a small distance, to avoid an accident caused by the user deviating far from a navigation route, thereby guiding the user to travel following the blind guide route, and further improving the travel safety for the user.

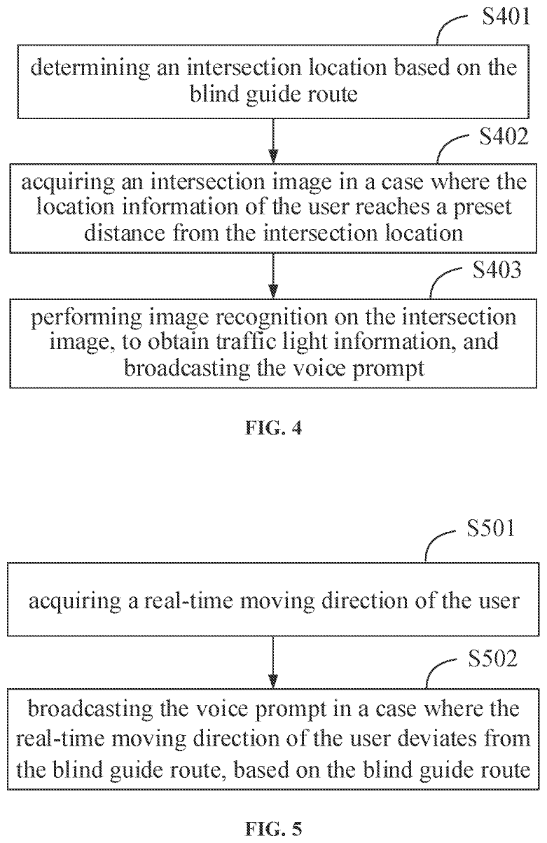

As shown in FIG. 4, in an implementation, S103 includes:

S401: determining an intersection location based on the blind guide route;

S402: acquiring an intersection image in a case where the location information of the user reaches a preset distance from the intersection location; and

S403: performing image recognition on the intersection image, to obtain traffic light information, and broadcasting the voice prompt.

The intersection location refers to location information of one or more intersections that a user needs to pass through in a case of following a blind guide route.

Illustratively, the determined intersection location includes a starting point location of the intersection and a destination location of the intersection. Based on the real-time location information of the user determined in S101, in a case where the location information of the user reaches a preset distance from the starting point location of the intersection, a real-time, image of the intersection is acquired through a camera on the blind guide product, and traffic light information in the image of the intersection is recognized by using an image recognition technology. In a case where the traffic light information is red or yellow, a voice prompt is broadcast to guide a passerby to stop moving. For example, the voice prompt may be “the front is an intersection, and the current traffic light is red (yellow), please stay at the current location and wait”. In a case where the traffic light information is green, a voice prompt is broadcast to guide the passerby to keep walking. For example, the voice prompt may be “the front is an intersection, and the current traffic light is green, please keep walking”.

It should be noted that, the accurate location for the user is achieved based on S101, and a specific value of the preset distance may be a meter level or a decimeter level. For example, the preset distance may be 1 meter, that is, in a case where the user reaches 1 meter from the starting point location of the intersection, the intersection image is acquired immediately and the traffic light information is recognized, and the user is guided to stop or move forward. As a result, it may be accurately determined whether the user is close to the intersection during the travel, and an image recognition technology is used to inform the user of the traffic light information, to guide the blind to pass through the intersection safely, thereby avoiding the situation that a blind enters the intersection before getting a voice prompt of the traffic light information due to low location accuracy, so that the voice prompt may be broadcast to the user timely and accurately, and the safety of the user in a case of passing through the intersection is improved.

As shown in FIG. 5, in an implementation, S103 includes:

S501: acquiring a real-time moving direction of the user; and

S502: broadcasting the voice prompt in a case where the real-time moving direction of the user deviates from the blind guide route, based on the blind guide route.

Illustratively, in S501, the real-time moving direction of the user may be obtained by using a geomagnetic sensor. It may be understood that the geomagnetic sensor is a sensor detecting magnetic force of the earth, and is also called an “electronic compass”. The geomagnetic sensor may detect a current movement direction of the user by detecting the magnetic force of the earth. In addition, in other examples of the present disclosure, the real-time moving direction of the user may also be obtained by using a gyroscope.

Illustratively, in S502, in a case where an angle between the real-time moving direction of the user and the blind guide route reaches a preset angle, it is determined that the user currently has deviated from the blind guide route, and a voice prompt such as “your current forward direction has deviated from the blind guide route, please turn left (right) to adjust your forward direction” is broadcast, so as to guide the user to adjust the moving direction and move forward in accordance with the blind guide route.

It should be noted that in a case of traveling to a certain road section, for example, in the process of passing through an intersection (namely, in the process of traveling from the starting point location of the intersection to the destination location of the intersection), due to complex vehicle conditions and intersection of a plurality of roads, the user needs to strictly follow the blind guide route to reduce the risk. By judging whether the moving direction of the user deviates from the blind guide route, an early warning may be issued to the user in advance before an actual location of the user deviates from the guide route, to prompt the user to adjust the direction and travel strictly in accordance with the blind guide route. As a result, the safety of the user may be improved in a case where crossing through a complex road section, and the probability of risk may be further reduced.

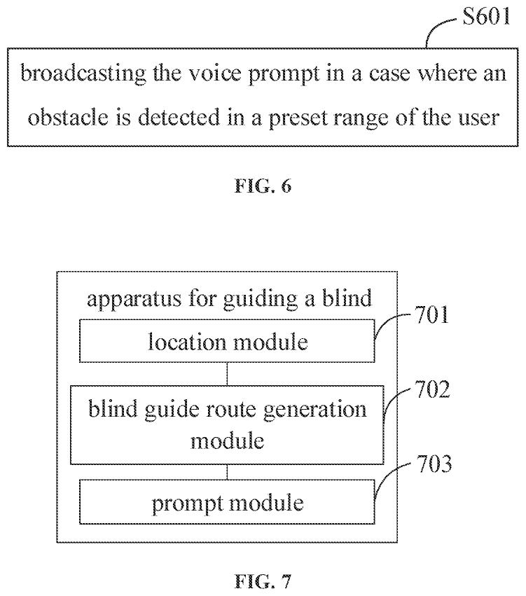

As shown in FIG. 6, in an implementation, the method further includes:

S601: broadcasting the voice prompt in a case where an obstacle is detected in a preset range of the user.

Illustratively, an ultrasonic sensor may be used to detect whether there is an obstacle in a preset range, that is, whether there is an object that forms an obstacle to a user in the preset range, such as a vehicle, another pedestrian and the like. In addition, in a case where an obstacle is detected in the preset range, a voice prompt such as “an obstacle is detected ahead, please stop moving forward (or please detour left and right)” will be broadcast. The preset range may be set according to actual requirements, for example, it may be 2 meters.

According to the foregoing implementations, by detecting obstacles within the preset range of the user and broadcasting a voice prompt, it may warn the user of obstacle information during the travel process, thereby further reducing the probability of danger and improving travel safety.

According to an embodiment of the present disclosure, an apparatus for guiding a blind is further provided.

As shown in FIG. 7, the apparatus includes:

a location module 701, configured for acquiring Beidou satellite data and base station differential data, and determining location information of a user by using a carrier phase differential technology;

a blind guide route generation module 702, configured for in response to a blind guide request, generating a blind guide route according to current location information and destination information input by the user; and

a prompt module 703, configured for broadcasting a voice prompt based on the blind guide route.

In an implementation, the blind guide route generation module 702 includes:

a starting point location determination submodule, configured for determining a starting point location on a preset map according to the current location information;

a destination location determination submodule, configured for performing voice recognition on a voice input by the user, to obtain the destination information, and determining a destination location on the preset map; and

a blind guide route determination submodule, configured for determining the blind guide route on the preset map based on the starting point location and the destination location.

In an implementation, the prompt module 703 is further configured for:

broadcasting the voice prompt in a case where the location information of the user deviates from the blind guide route, based on the blind guide route.

In an implementation, the prompt module 703 is further configured for:

determining an intersection location based on the blind guide route;

acquiring an intersection image in a case where the location information of the user reaches a preset distance from the intersection location; and

performing image recognition on the intersection image, to obtain traffic light information, and broadcasting the voice prompt.

In an implementation, the prompt module 703 is further configured for:

acquiring a real-time moving direction of the user; and

broadcasting the voice prompt in a case where the real-time moving direction of the user deviates from the blind guide route, based on the blind guide route.

In an implementation, the prompt module is further configured for:

broadcasting the voice prompt in a case where an obstacle is detected in a preset range of the user.

According to an embodiment of the present disclosure, a product for guiding a blind is further provided, including the apparatus for guiding a blind according to any implementation of the present disclosure.

Illustratively, the product for guiding a blind of the embodiment of the present disclosure may be a product with the function of guiding a blind, such as a blind guide stick, a blind guide device, a blind guide robot.

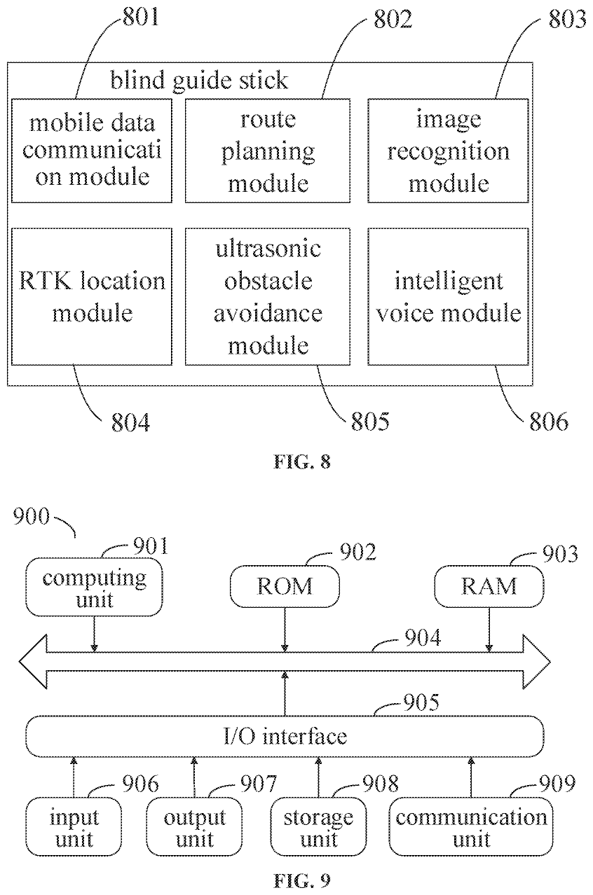

As shown in FIG. 8, the blind guide stick is taken as an example to describe the product for guiding a blind of the embodiments of the present disclosure in detail.

As shown in FIG. 8, the blind guide stick includes a mobile data communication module 801, a route planning module 802, an image recognition module 803, a RTK location module 804, an ultrasonic obstacle avoidance module 805, and an intelligent voice module 806. The mobile data communication module 801 and the RTK location module 804 constitute the location module of the apparatus for guiding a blind mentioned above; the route planning module 802 and the intelligent voice module 806 constitute the blind guide route generation module of the apparatus for guiding a blind mentioned above; the RTK location module 804 and the ultrasonic obstacle avoidance module 805, the image recognition module 803 and the intelligent voice module 806 constitute the prompt module of the apparatus for guiding a blind mentioned above.

Specifically, the blind guide stick receives Beidou satellite data through the Beidou chip placed inside the blind guide stick, and receives base station differential data at the same time through the mobile data communication module 801. Then, the Beidou satellite data and the base station differential data are synchronized into the RTK location module 804, to obtain precise location information of the blind guide stick (namely, the user).

Based on the precise location information of the RTK location module 804 and high-precision map data, the starting point location is determined. The intelligent voice module 806 receives and recognizes a voice input by a blind to obtain the destination location, and the route planning module 802 generates a blind guide route according to the starting point location and the destination location.

The RTK location module 804 locates the blind in real time in the process of traveling of the user, to determine whether the user deviates from the blind guide route, and broadcasts a voice prompt through the intelligent voice module 806 in a case where the user deviates from the blind guide route. Meanwhile, the ultrasonic obstacle avoidance module 805 is used to check whether there is an obstacle around the user, and in a case where there is an obstacle, a voice prompt is broadcast to the user through the intelligent voice module 806. In a case where the user arrives at the intersection, a camera built in the blind guide stick is used to photograph the intersection, the image recognition module 803 is used to recognize the traffic light information of the intersection, and the intelligent voice module 806 is used to broadcast the traffic light information to the user, to guide the user to stop or keep walking. In a case where the blind passes through the intersection, because the intersection is not paved with blind tracks, it is determined by the geomagnetic sensor built in the blind guide stick whether the traveling direction of the user is consistent with the blind guide route, and in a case where the traveling direction of the user deviates from the blind guide route, the intelligent voice module 806 guides the user to adjust the direction and follow the blind guide route to pass through the intersection.

According to the product for guiding a blind in the embodiments of the present disclosure, the sub-meter level location of the blind guide stick may be realized by utilizing the Beidou satellite data and the base station differential data, and through the RTK carrier phase differential technology. Moreover, the blind guide route may be planned based on a RTK location technology and high-precision electronic map data. Furthermore, based on the intelligent voice module 806, the geomagnetic sensor, the camera and the image recognition module 803 built in the blind guide stick, the traffic light information of the intersection may be determined, and the blind may be guided to pass through the intersection safely. As a result, the product for guiding a blind in the embodiments of the present disclosure resolves the technical problem that location accuracy of the blind guide stick cannot meet blind guide requirements in a complex road section (such as an intersection), and achieves the planning of a high-precision navigation route through the RTK location technology and the high-precision electronic map, and guides the user to pass through the intersection safely and conveniently through a plurality of built-in sensors.

According to embodiments of the present disclosure, the present disclosure also provides an electronic device, a readable storage medium and a computer program product.

FIG. 9 shows a schematic block diagram of an example electronic device 900 that may be used to implement embodiments of the present disclosure. The electronic device is intended to represent various forms of digital computers, such as laptop computers, desktop computers, workstations, personal digital assistants, servers, blade servers, mainframe computers, and other suitable computers. The electronic device may also represent various forms of mobile devices, such as a personal digital assistant, a cellular telephone, a smart phone, a wearable device, and other similar computing devices. The components shown herein, their connections and relationships, and their functions are by way of example only and are not intended to limit the implementations of the present disclosure described and/or claimed herein.

As shown in FIG. 9, the electronic device 900 includes a computing unit 801 that may perform various suitable actions and processes in accordance with computer programs stored in a read only memory (ROM) 902 or computer programs loaded from a storage unit 908 into a random access memory (RAM) 903. In the RAM 903, various programs and data required for the operation of the electronic device 900 may also be stored. The computing unit 901, the ROM 902 and the RAM 903 are connected to each other through a bus 904. An input/output (I/O) interface 905 is also connected to the bus 904.

A plurality of components in the electronic device 900 are connected to the I/O interface 905, including: an input unit 906, such as a keyboard, a mouse, etc.; an output unit 907, such as various types of displays, speakers, etc.; a storage unit 908, such as a magnetic disk, an optical disk, etc.; and a communication unit 909, such as a network card, a modem, a wireless communication transceiver, etc. The communication unit 909 allows the electronic device 900 to exchange information/data with other devices over a computer network, such as the Internet, and/or various telecommunications networks.

The computing unit 901 may be various general purpose and/or special purpose processing assemblies having processing and computing capabilities. Some examples of the computing unit 901 include, but are not limited to, a central processing unit (CPU), a graphics processing unit (GPU), various specialized artificial intelligence (AI) computing chips, various computing units running machine learning model algorithms, a digital signal processor (DSP), and any suitable processor, controller, microcontroller, etc. The computing unit 901 performs various methods and processes described above, such as the method for guiding a blind. For example, in some embodiments, the method for guiding a blind may be implemented as computer software programs that are physically contained in a machine-readable medium, such as the storage unit 908. In some embodiments, some or all of the computer programs may be loaded into and/or installed on the electronic device 900 via the ROM 902 and/or the communication unit 909. In a case where the computer programs are loaded into the RAM 903 and executed by the computing unit 901, one or more of steps of the method for guiding a blind may be performed. Alternatively, in other embodiments, the computing unit 901 may be configured to perform the method for guiding a blind in any other suitable manner (e.g., by means of a firmware).

Various implementations of the systems and techniques described herein above may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), a computer hardware, a firmware, a software, and/or a combination thereof. These various implementations may include an implementation in one or more computer programs, which can be executed and/or interpreted on a programmable system including at least one programmable processor; the programmable processor may be a dedicated or general-purpose programmable processor and capable of receiving and transmitting data and instructions from and to a storage system, at least one input device, and at least one output device.

The program codes for implementing the methods of the present disclosure may be written in any combination of one or more programming languages. These program codes may be provided to a processor or controller of a general purpose computer, a special purpose computer, or other programmable data processing apparatus such that the program codes, when executed by the processor or controller, enable the functions/operations specified in the flowchart and/or the block diagram to be performed. The program codes may be executed entirely on a machine, partly on a machine, partly on a machine as a stand-alone software package and partly on a remote machine, or entirely on a remote machine or server.

In the context of the present disclosure, the machine-readable medium may be a tangible medium that may contain or store programs for using by or in connection with an instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. More specific examples of the machine-readable storage medium may include one or more wire-based electrical connection, a portable computer diskette, a hard disk, a random access memory (RAM), a read-only memory (ROM), an erasable programmable read-only memory (EPROM or Flash memory), an optical fiber, a portable compact disk read-only memory (CD-ROM), an optical storage device, a magnetic storage device, or any suitable combination thereof.

In order to provide an interaction with a user, the system and technology described here may be implemented on a computer having: a display device (e. g., a cathode ray tube (CRT) or a liquid crystal display (LCD) monitor) for displaying information to the user; and a keyboard and a pointing device (e.g., a mouse or a trackball), through which the user can provide an input to the computer. Other kinds of devices can also provide an interaction with the user. For example, a feedback provided to the user may be any form of sensory feedback (e.g., visual feedback, auditory feedback, or tactile feedback); and an input from the user may be received in any form, including an acoustic input, a voice input or a tactile input.

The systems and techniques described herein may be implemented in a computing system (e.g., as a data server) that may include a background component, or a computing system (e.g., an application server) that may include a middleware component, or a computing system (e.g., a user computer having a graphical user interface or a web browser through which a user may interact with embodiments of the systems and techniques described herein) that may include a front-end component, or a computing system that may include any combination of such background components, middleware components, or front-end components. The components of the system may be connected to each other through a digital data communication in any forma or medium (e.g., a communication network). Examples of the communication network may include a local area network (LAN), a wide area network (WAN), and the Internet.

The computer system may include a client and a server. The client and the server are typically remote from each other and typically interact via the communication network. The relationship of the client and the server is generated by computer programs running on respective computers and having a client-server relationship with each other.

It should be understood that the steps can be reordered, added or deleted using the various flows illustrated above. For example, the steps described in the present disclosure may be performed concurrently, sequentially or in a different order, so long as the desired results of the technical solutions disclosed in the present disclosure can be achieved, and there is no limitation herein.

The above-described specific embodiments do not limit the scope of the present disclosure. It will be apparent to those skilled in the art that various modifications, combinations, sub-combinations and substitutions are possible, depending on design requirements and other factors. Any modifications, equivalent substitutions, and improvements within the spirit and principles of the present disclosure are intended to be included within the scope of the present disclosure.

What is claimed is:

1. A method for guiding a blind, comprising:
acquiring Beidou satellite data and base station differential data, and determining location information of a user by using a carrier phase differential technology;
in response to a blind guide request, generating a blind guide route according to current location information and destination information input by the user; and
broadcasting a voice prompt based on the blind guide route.

2. The method of claim 1, wherein the generating a blind guide route according to current location information and destination information input by the user, comprises:
determining a starting point location on a preset map according to the current location information;
performing voice recognition on a voice input by the user, to obtain the destination information, and determining a destination location on the preset map; and
determining the blind guide route on the preset map based on the starting point location and the destination location.

3. The method of claim 1, wherein the broadcasting a voice prompt based on the blind guide route, comprises:
broadcasting the voice prompt in a case where the location information of the user deviates from the blind guide route, based on the blind guide route.

4. The method of claim 1, wherein the broadcasting a voice prompt based on the blind guide route, comprises:
determining an intersection location based on the blind guide route;
acquiring an intersection image in a case where the location information of the user reaches a preset distance from the intersection location; and
performing image recognition on the intersection image, to obtain traffic light information, and broadcasting the voice prompt.

5. The method of claim 1, wherein the broadcasting a voice prompt based on the blind guide route, comprises:
acquiring a real-time moving direction of the user; and
broadcasting the voice prompt in a case where the real-time moving direction of the user deviates from the blind guide route, based on the blind guide route.

6. The method of claim 1, further comprising:
broadcasting the voice prompt in a case where an obstacle is detected in a preset range of the user.

7. An electronic device, comprising:
at least one processor; and
a memory communicatively connected with the at least one processor,
wherein the memory stores instructions executable by the at least one processor, the instructions being executed by the at least one processor to enable the at least one processor to execute operations of:
acquiring Beidou satellite data and base station differential data, and determining location information of a user by using a carrier phase differential technology;
in response to a blind guide request, generating a blind guide route according to current location information and destination information input by the user; and
broadcasting a voice prompt based on the blind guide route.

8. The electronic device of claim 7, wherein the generating a blind guide route according to current location information and destination information input by the user, comprises:
determining a starting point location on a preset map according to the current location information;
performing voice recognition on a voice input by the user, to obtain the destination information, and determining a destination location on the preset map; and
determining the blind guide route on the preset map based on the starting point location and the destination location.

9. The electronic device of claim 7, wherein the broadcasting a voice prompt based on the blind guide route, comprises:
broadcasting the voice prompt in a case where the location information of the user deviates from the blind guide route, based on the blind guide route.

10. The electronic device of claim 7, wherein the broadcasting a voice prompt based on the blind guide route, comprises:
determining an intersection location based on the blind guide route;
acquiring an intersection image in a case where the location information of the user reaches a preset distance from the intersection location; and
performing image recognition on the intersection image, to obtain traffic light information, and broadcasting the voice prompt.

11. The electronic device of claim 7, wherein the broadcasting a voice prompt based on the blind guide route, comprises:
acquiring a real-time moving direction of the user; and
broadcasting the voice prompt in a case where the real-time moving direction of the user deviates from the blind guide route, based on the blind guide route.

12. The electronic device of claim 7, wherein the instructions are executable by the at least one processor to enable the at least one processor to further execute an operation of:
broadcasting the voice prompt in a case where an obstacle is detected in a preset range of the user.

13. A non-transitory computer-readable storage medium storing computer instructions for enabling a computer to execute operations of:
acquiring Beidou satellite data and base station differential data, and determining location information of a user by using a carrier phase differential technology;
in response to a blind guide request, generating a blind guide route according to current location information and destination information input by the user; and
broadcasting a voice prompt based on the blind guide route.

14. The non-transitory computer-readable storage medium of claim 13, wherein the generating a blind guide route according to current location information and destination information input by the user, comprises:
determining a starting point location on a preset map according to the current location information;
performing voice recognition on a voice input by the user, to obtain the destination information, and determining a destination location on the preset map; and
determining the blind guide route on the preset map based on the starting point location and the destination location.

15. The non-transitory computer-readable storage medium of claim 13, wherein the broadcasting a voice prompt based on the blind guide route, comprises:
broadcasting the voice prompt in a case where the location information of the user deviates from the blind guide route, based on the blind guide route.

16. The non-transitory computer-readable storage medium of claim 13, wherein the broadcasting a voice prompt based on the blind guide route, comprises:
determining an intersection location based on the blind guide route;
acquiring an intersection image in a case where the location information of the user reaches a preset distance from the intersection location; and
performing image recognition on the intersection image, to obtain traffic light information, and broadcasting the voice prompt.

17. The non-transitory computer-readable storage medium of claim 13, wherein the broadcasting a voice prompt based on the blind guide route, comprises:
acquiring a real-time moving direction of the user; and
broadcasting the voice prompt in a case where the real-time moving direction of the user deviates from the blind guide route, based on the blind guide route.

18. The non-transitory computer-readable storage medium of claim 13, wherein the computer instructions are executable by the computer to enable the computer to further execute an operation of:
broadcasting the voice prompt in a case where an obstacle is detected in a preset range of the user.

19. A blind guide product comprising the electronic device for guiding a blind of claim 7.

20. A blind guide product comprising the electronic device for guiding a blind of claim 8.
